(19) United States
(12) Patent Application Publication
(10) Pub. No.: US 2016/0156003 A1
(43) Pub. Date: Jun. 2, 2016

(54) PORTABLE BATTERY DEVICE

(71) Applicant: OJMAR, S.A., Elgoibar (Guipuzcoa) (ES)

(72) Inventor: Jon ZABALA ZABALETA, ELGOIBAR (Guipuzcoa) (ES)

(21) Appl. No.: 14/886,130

(22) Filed: Oct. 19, 2015

(30) Foreign Application Priority Data
Dec. 2, 2014 (ES) 201431556

(51) Int. Cl. H01M 2/10; H01M 10/48

(52) U.S. Cl. CPC H01M 2/1022; H01M 10/488; H01M 2220/30

(57) ABSTRACT

A portable battery device which comprises two separable parts: a) a support (1), attached permanently or in extractable fashion to a piece of electrical, electronic or electromechanical equipment which is energised by the portable battery device, in which the support (1) is connected by means of at least one electrical contact (4) to said electrical, electronic or electromechanical unit, and; b) a battery (2), attached in extractable fashion to the support (1), connected electrically and mechanically to said support (1), with the battery comprising a charging socket (3) to connect it by means of a cable to a power socket.

### OBJECT OF THE INVENTION

This invention refers to a portable battery device comprising a support structure and a battery.

The device which is the object of this invention has the singular and innovative feature of consisting of a portable battery formed of a structure which can be disassembled, by means of which it is possible to recharge the part corresponding to the battery, strictly speaking, independently of the support for said battery and the electrical/electronic equipment in which the battery is inserted.

Its application is in the industry devoted to the manufacture, design and commercialisation of batteries and electronic accessories.

### TECHNICAL PROBLEM TO ADDRESS AND BACKGROUND OF THE INVENTION

In the state of the art, numerous types of batteries for electrical and/or electronic equipment are known.

There are numerous items of electrical/electronic equipment which are powered by a direct connection to the mains, or via an indirect connection, by means of a battery and/or transformer/converter.

Electrical/electronic equipment which uses batteries for power can generally operate when disconnected from the mains, consuming power from the battery, which can subsequently be recharged by connecting said battery to the mains.

On the other hand, said equipment with the battery connected can also operate in a conventional manner when permanently connected to the mains, so that, at the same time as the equipment consumes power from the battery, said battery is constantly recharged through its connection to the mains.

There are many types of equipment which use rechargeable batteries of all kinds, ranging from portable radios, in which the battery may consist of cell-type batteries or internal batteries which cannot be extracted from the radio, to remote control units, camping lights, interactive toys, laptop computers, etc.

In some electrical/electronic equipment, the batteries must generally be recharged when they are inserted in the equipment itself, making it necessary to have the whole item of equipment plugged into the mains for the battery to be recharged.

It goes without saying that this generates inconvenience for the user. Everyone has experienced a situation in which the user trips over the cable connecting the electrical/electronic equipment to the mains, bringing the equipment crashing to the floor.

The portable battery device presented avoids the abovementioned drawbacks, because its shape and arrangement make it possible to disassociate the battery charging operation of a piece of electrical/electronic equipment from a certain positioning of said electrical/electronic equipment.

Other known devices may use rechargeable batteries: in the state of the art, there are a variety of types of electronic locks which are incorporated in doors to premises or lockers. Said locks are incorporated either as an element which is inseparable from said doors (introduced as an internal element during the door manufacturing stage) or as an accessory attached to the door, which is accessible from the outside for repair and/or replacement.

In addition, the portable batteries currently on the market have the disadvantage that they are difficult to connect to the electrical/electronic equipment, either because of the situation in which said electrical/electronic equipment is installed, or because of the location of the connection to the power source.

For all the equipment mentioned, it is very useful to have portable rechargeable batteries which can be connected easily and in versatile fashion to said equipment, and which can be recharged without having to move the whole piece of equipment closer to a power socket and/or without having to run a cable of large dimensions from the power socket to the location of the electrical/electronic equipment.

The portable battery device presented offers a solution to the problems posed, and supposes an innovative and attractive way of having a reliable, light and highly versatile power source available anywhere.

### DESCRIPTION OF THE INVENTION

This invention refers to a portable battery device comprising two separable parts: on the one hand a support, attached permanently or in extractable fashion to a piece of electrical, electronic or electromechanical equipment which is energised by the portable battery device, wherein the support is connected by at least one electrical contact to said electrical, electronic or electromechanical equipment; and, on the other hand, a battery, attached in extractable fashion to the support, connected electrically and mechanically to said support, with the battery comprising a charging socket to connect it by means of a cable to a power socket.

The portable battery device which is the object of this invention may be manufactured in a variety of materials and shapes, allowing it to be adapted correctly to the electrical, electronic or electromechanical equipment for which it is intended.

The shape of the support and the battery is such that they can be coupled perfectly, with a perfect electrical contact between the two parts.

In addition, the support is coupled to the electrical, electronic or electromechanical equipment for which the device is intended, and may be uncoupled from said equipment when desired, or the support may be left coupled to said equipment permanently; in this case, only the battery is extracted when discharged, to be charged and possibly replaced by another charged battery which is coupled to the support.

The battery typically comprises tabs which fit into recesses in the support, so that both parts fit together correctly.

Both the battery and the support have orifices in the front which allow the battery and the support to be uncoupled from each other, when fingers are inserted and slight pressure is applied.

The support typically comprises at least one fixing orifice, into which an element can be introduced (a screw or a pin) to fix said support to an external surface or to the chassis of a piece of electrical/electronic equipment.

The battery is connected electrically to the support, preferably by means of elastic elements (springs), which also ensure that the coupling between the battery and the support is correct.

The battery in the device also includes, in a preferred embodiment, a visual indicator of the charge level.

Consequently, as can be seen from this description and the accompanying figure, this invention provides a device which is highly versatile, convenient, easy to handle, portable and highly reliable in terms of performance and electrical safety, which makes it possible to disassociate not only the electrical power for a piece of electrical, electronic or electromechanical equipment from the electricity mains, but also disassociate the recharging of said equipment from the mains; this is because the battery can be extracted from the equipment and recharged independently of the equipment itself, and can also be replaced with another battery which is already charged.

The battery device presented is designed particularly to be used in electrical, electronic or electromechanical systems, as described previously.

The device described offers a solution to problems of difficult access to electrical/electronic equipment. Because it has a support fixed to the electrical/electronic equipment, problems caused by poor connections are solved. The battery is inserted and extracted simply (with no tools required), which means that this operation can be carried out in places which are difficult to access, such as, for example, in a lock for furniture located inside said item of furniture.

### BRIEF DESCRIPTION OF THE FIGURES

This invention will be understood better with the help of the following figures.

FIG. 1: Shows a schematic view of the device which is the object of this invention.

FIG. 1 incorporates the following numerical references:

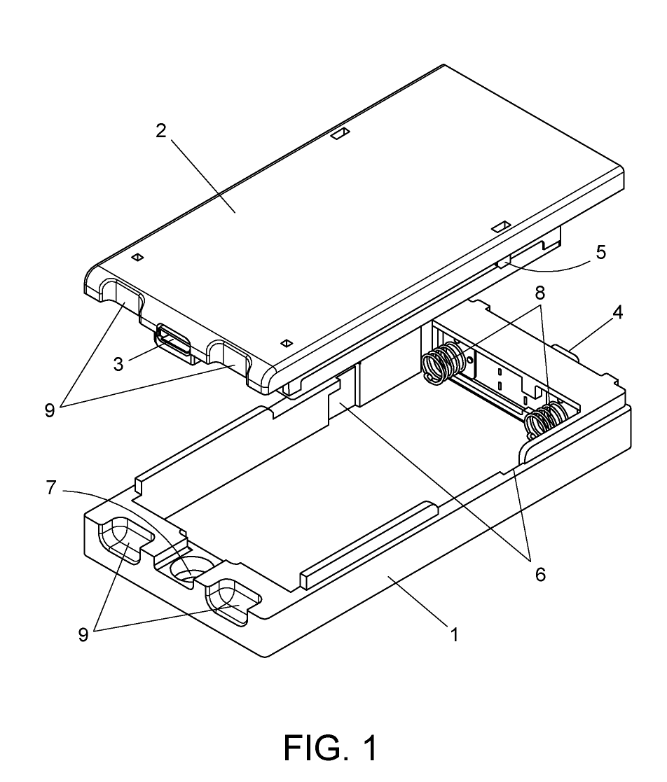

1. Support.

2. Battery.

3. Recharge socket.

4. Electrical contact.

5. Tabs.

6. Recesses

7. Fixing orifice.

8. Elastic elements.

9. Front orifices.

### DETAILED DESCRIPTION

Presented below is a detailed description of a preferred embodiment of the portable battery device.

The portable battery device can be disassembled, and comprises two separable parts, which are: a support (1) and a battery (2) connected mechanically and electrically to said support (1).

Typically, the support (1) is attached permanently to a piece of electrical, electronic or electromechanical equipment. However, said support can be extracted from said equipment when required.

The battery (2) is designed to be extracted from the support (1), to be recharged by connecting it, using a recharging socket (3) in the battery (2) to a conventional power socket, using a charging cable (not shown).

Typically, the recharging socket (3) in the battery (2) is of the USB type, although any other type of electrical connection can be used.

The support (1) also comprises an electrical contact (4), for electrical connection to the electrical, electronic or electromechanical equipment which is powered by the portable battery device.

Typically, the electrical contact (4) is of the USB type, although any other type of electrical connection can also be used, allowing a cable or adapter to be connected both to the electrical, electronic or electromechanical equipment and to the support (1).

In addition, the battery (2) is of a shape which complements that of the support (1), so that it fits perfectly into the support (1).

Similarly, the shape of the support (1) is such that it attaches perfectly to the electrical, electronic or electromechanical equipment it powers.

The coupling between the battery (2) and the support (1) is typically made, as can be seen in the figure, by tabs (5) in the battery (2) which are inserted into recesses (6) in the support.

Meanwhile, the support comprises a fixing orifice (7) which can be used to fix it, using a screw or a pin, to a fixed surface, a door or the chassis of a piece of electrical, electronic or electromechanical equipment.

In addition, in a preferred embodiment of this portable battery device, elastic elements (8) are responsible for connecting mechanically and electrically the battery (2) and the support (1), ensuring that the battery (2) fits perfectly in the support (1) and does not come out of the support while the portable battery device is operating.

A further feature of the device are orifices in the front (9), which are designed to have fingers inserted in them and slight pressure applied, to extract the battery (2) easily from the support (1).

The battery (2) also has the necessary electronics to ensure correct charging, and includes a visual indicator (not shown) of the charge level, which allows the user to see at all times whether or not recharging is necessary.

1. A portable battery device characterised in that it comprises two separable parts:
a. a support (1), attached permanently or in extractable fashion to an item of electrical, electronic or electromechanical equipment which is energised by the portable battery device, in which the support (1) is connected by means of at least one electrical contact (4) to said electrical, electronic or electromechanical unit, and;
b. a battery (2), attached in extractable fashion to the support (1), connected electrically and mechanically to said support (1), with the battery comprising a charging socket (3) to connect it via a cable to a power socket.

2. A portable battery device according to claim 1, characterised in that the battery (2) comprises tabs (5) which fit into recesses (6) in the support (1), in such a way that both parts are correctly coupled.

3. A portable battery device according to claim 1, characterised in that both the battery (2) and the support (1) comprise front orifices (9) which allow the battery (2) to be uncoupled from the support (1).

4. A portable battery device according to claim 1, characterised in that the support comprises at least one fixing orifice (7), for a fixing element to be inserted to fix said support (1) to an external surface.

5. A portable battery device according to claim 1, characterised in that the battery (2) is connected electrically to the support (1) by means of elastic elements (8) which also ensure that the coupling between the battery (2) and the support(1) is correct.

6. A portable battery device according to claim 1, characterised in that the battery (2) has a visual indicator of the level of charge.
